(19) United States
(12) Patent Application Publication
(10) Pub. No.: US 2026/0120483 A1
(43) Pub. Date: Apr. 30, 2026

(54) AUTOMOTIVE OBJECT IDENTIFICATION AND NOTIFICATION UTILIZING PROMPT ENGINEERED VISION-LANGUAGE MODELS

(71) Applicant: Volkswagen Aktiengesellschaft, Wolfsburg (DE)

(72) Inventors: Rakshatha Attuluri, Newark, CA (US); Gerardo Rossano, Saratoga, CA (US); Zi Min Sun, Belmont, CA (US); Mihir Keskar, San Francisco, CA (US); Adam Coogan, San Francisco, CA (US); Safin Salih, Belmont, CA (US)

(21) Appl. No.: 18/927,746

(22) Filed: Oct. 25, 2024

(51) Int. Cl. G06V 20/59; G06V 10/25; G06V 10/26; G06V 10/70; G08B 21/24; H04L 12/40

(52) U.S. Cl. CPC G06V 20/59; G06V 10/25; G06V 10/26; G06V 10/70; G08B 21/24; H04L 12/40; H04L 2012/40215; H04L 2012/40273

(57) ABSTRACT

Technologies and techniques for detecting and identifying objects within a vehicle interior are disclosed. One or more cameras capture image data of the vehicle interior, which is processed and analyzed using a vision-language model (VLM) to detect and identify objects based on their visual and contextual characteristics. The system associates the identified objects with locations inside the vehicle and generates notifications containing the object details and locations. The detection criteria are dynamically updated based on contextual factors, such as vehicle location, environmental conditions, and user preferences. The system further adjusts future object detection criteria based on feedback received from users, enabling improved detection accuracy. Additionally, the system can identify partially obscured objects using image segmentation and contextual recognition techniques. Notifications are communicated through an interface or connected mobile devices, allowing users to interact with the detected objects and receive real-time updates on their locations.

### TECHNICAL FIELD

The present disclosure relates to technologies and techniques for detecting and identifying objects within a vehicle cabin using in-cabin imaging and artificial intelligence technologies. More specifically, it pertains to the integration of vision-language models and onboard/offboard computational modules to perform real-time object detection, localization, and user notification in automotive environments.

### BACKGROUND

In recent years, advancements in automotive technology have enhanced driver comfort, safety, and convenience. However, the management and tracking of personal items within a vehicle cabin remain areas with limited innovation. Drivers and passengers frequently carry various belongings such as bags, electronic devices, wallets, and keys. These items are often misplaced within the vehicle or inadvertently left behind, leading to inconvenience and potential loss/theft.

Existing solutions for tracking personal items typically rely on manual tagging systems. Users may attach physical tags or electronic devices like RFID tags or Bluetooth trackers to individual items. Services like AFindMy network and AirTags enable users to locate tagged objects; however, these solutions require proactive user participation to tag each item of interest. This approach is impractical for tracking multiple or frequently changing personal items and does not assist in identifying untagged objects within the vehicle.

Conventional in-cabin monitoring systems are generally designed for specific functions such as occupant detection, driver assistance, or basic security surveillance. These systems often employ limited image recognition algorithms or simple sensors that recognize only predefined objects or patterns. They lack the flexibility to identify a diverse array of personal items and may struggle with varying interior designs, lighting conditions, and common obstructions within vehicle cabins.

Another limitation of current technologies is the lack of timely and contextually relevant notifications about personal belongings. Systems that do not activate upon specific vehicle operational events—such as the driver shifting to “PARK” or opening a door by any occupant of a vehicle—may miss critical opportunities to alert users about items that have been left behind or misplaced. Moreover, without the capability to localize detected objects within specific regions of the cabin, the usefulness of the information provided to the user is significantly diminished.

Advancements in artificial intelligence (AI), particularly in vision-language models, have opened new possibilities for in-cabin object detection and identification. These models are trained on extensive datasets and can recognize a wide variety of objects without the need for manual tagging. However, integrating such complex models into the automotive environment presents technical challenges. These include the need for real-time processing capabilities within the vehicle, efficient management of computational resources, and ensuring user privacy and data security.

Therefore, there is a need for technologies and techniques that overcome the limitations of prior technologies by providing robust, real-time detection and localization of a wide range of objects within a vehicle cabin without relying on manual tagging. Such a system should effectively handle diverse interior configurations and lighting conditions, integrate seamlessly with vehicle operational events, and present information to the user in a clear and actionable manner. Additionally, it should address the computational and integration challenges associated with deploying advanced AI models in an automotive context.

### SUMMARY

The present disclosure provides a system and method for detecting and identifying personal objects within a vehicle cabin using in-cabin imaging and artificial intelligence. By integrating strategically placed cameras and onboard computational modules utilizing advanced vision-language models, the system captures images of the cabin interior and processes them to recognize a wide array of objects of interest without the need for manual tagging. Triggered by specific vehicle events such as shifting to “PARK” or opening a door, the system provides real-time notifications to the user through the vehicle's infotainment system or mobile devices, thereby enhancing user convenience and preventing the loss or misplacement of personal items within the vehicle.

In some examples, a method is disclosed for detecting and identifying objects within a vehicle interior. In various embodiments, the method may comprise capturing image data of the vehicle interior using one or more cameras; processing the captured image data to generate optimized image data for object detection; analyzing the optimized image data using a vision-language model (VLM) to detect and identifying one or more objects present within the vehicle interior, wherein the VLM is configured to recognize one or more objects based on their visual and contextual characteristics; associating the identified one or more objects with a location within the vehicle interior; generating a notification comprising the detected one or more objects and one or more respective locations within the vehicle interior; dynamically updating the object detection criteria based on contextual information, comprising one or more of vehicle location, environmental conditions, and user preferences; and adjusting future object detection criteria based on received feedback regarding the relevance or priority of the identified objects.

In some examples, a system is disclosed for detecting and identifying objects within a vehicle interior. In various embodiments, the system may comprise one or more cameras configured to capture image data of the vehicle interior; and computational circuitry, operatively coupled to the one or more cameras, the computational circuitry being configured to process the captured image data to generate optimized image data for object detection; analyze the optimized image data using a vision-language model (VLM) to detect and identify one or more objects present within the vehicle interior, wherein the VLM is configured to recognize one or more objects based on their visual and contextual characteristics; associate the identified one or more objects with a location within the vehicle interior; generate a notification comprising the detected one or more objects and one or more respective locations within the vehicle interior; dynamically update object detection criteria based on contextual information, comprising one or more of vehicle location, environmental conditions, and user preferences; and adjust future object detection criteria based on feedback regarding the relevance or priority of the identified objects.

In some examples, a method is disclosed for detecting and identifying objects within a vehicle interior. In various embodiments, the method may comprise receiving an operational signal detected via a Controller Area Network (CAN); in response to receiving the operational signal, triggering one or more cameras to capture image data of the vehicle interior; processing the captured image data to generate optimized image data for object detection; analyzing the optimized image data using a vision-language model (VLM) to detect and identify one or more objects present within the vehicle interior, wherein the VLM is configured to recognize the one or more objects based on their visual and contextual characteristics; associating the identified one or more objects with a location within the vehicle interior; generating a notification comprising the detected one or more objects and their respective locations within the vehicle interior; dynamically updating the object detection criteria based on contextual information, comprising one or more of vehicle location, environmental conditions, and user preferences; and adjusting future object detection criteria based on received feedback regarding the relevance or priority of the identified objects.

### BRIEF DESCRIPTION OF THE DRAWINGS

The present invention is illustrated by way of example and not limitation in the figures of the accompanying drawings, in which like references indicate similar elements and in which:

FIG. 1 illustrates a system block diagram depicting the components of an object detection system, including in-cabin cameras, computational modules, vision-language models, vehicle integration circuitry, user interface/display, and communication circuitry, according to some aspects of the present disclosure;

FIG. 2 shows a process flow for object detection and identification triggered by a vehicle event, including image capture, object identification, localization, and classification using vision-language models, according to some aspects of the present disclosure;

FIG. 3 illustrates a process flow for object detection and identification triggered by another vehicle event, including steps for image capture, object identification, localization, and notification generation, according to some aspects of the present disclosure;

FIG. 4 depicts a vehicle being configured to communicate with a portable device and cloud-based services, enabling remote notifications and object tracking, according to some aspects of the present disclosure;

FIG. 5 shows an example of an infotainment display presenting detected objects and their localized positions within the vehicle cabin, according to some aspects of the present disclosure;

FIG. 6 illustrates an example of a mobile device interface, which displays a notification regarding left-behind objects, and allows users to interact with the detected objects by acknowledging or prioritizing them, as well as object settings, according to some aspects of the present disclosure;

FIG. 7 illustrates an adaptive object detection system that incorporates additional features such as user feedback loops, user profiles, environment and context detection, object prioritization, and cloud-connected learning, allowing the system to adjust its behavior based on individual preferences and real-time feedback, according to some aspects of the present disclosure; and

FIG. 8 illustrates a process flow for object detection and identification triggered by an operational signal detected via the vehicle's CAN, according to some aspects of the present disclosure.

### DETAILED DESCRIPTION

The figures and descriptions provided herein may have been simplified to illustrate aspects that are relevant for a clear understanding of the herein described devices, structures, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

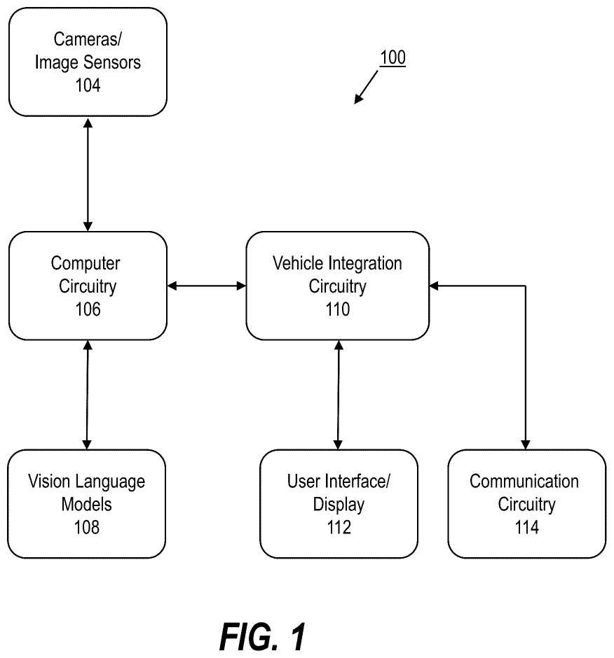

FIG. 1 illustrates a block diagram of the system 100 for detecting and identifying personal objects within a vehicle cabin, according to some aspects of the present disclosure. The system 100 may comprise several core components, including cameras or image sensors 104, computational circuitry 106, VLMs 108, vehicle integration circuitry 110, user interface/display 112, and communication circuitry 114. These components may operate together to perform the functions of object detection, identification, localization, and user notification.

In some examples, the cameras 104 may be strategically positioned within the vehicle cabin to provide a comprehensive field of view (FOV). The cameras 104 may include high-resolution digital image sensors capable of capturing images in various lighting conditions, including low-light scenarios. The cameras 104 may be equipped with features such as high dynamic range (HDR) and automatic exposure control to ensure image clarity. In certain embodiments, the cameras 104 may include wide-angle lenses to capture the entire vehicle cabin, ensuring that all areas where personal items may be placed are covered. The number and positioning of the cameras 104 may vary depending on the vehicle design to maximize cabin coverage.

The images captured by cameras 104 may be processed by the computational circuitry 106, which may be configured to handle both image pre-processing and the advanced computational tasks required for VLM inference. Upon capturing an image frame, several pre-processing steps may be performed to optimize the image data for analysis by the VLM.

Initially, when the in-cabin camera frame is captured at a designated trigger event (e.g., a gear shift change or door opening), the exposure of the image may be automatically adjusted based on the lighting conditions inside the vehicle cabin. Exposure adjustment may involve the use of adaptive histogram equalization (AHE), which enhances contrast by adjusting pixel brightness relative to surrounding areas. This ensures that objects within the vehicle cabin are visible, even in challenging lighting scenarios such as low light or high contrast environments. In some examples, Gaussian noise reduction may be applied to eliminate image noise generated in low-light conditions or by high ISO settings, resulting in a cleaner image that improves detection accuracy.

Following image capture and exposure optimization, the frame may be cropped into segments. In some examples, the image may be divided into ‘n’ parts, where ‘n’ may be defined as four quadrants, or specific regions of interest (ROI) may be determined based on the likely location of objects (e.g., seats, floor areas, storage compartments). ROI cropping may focus computational resources on critical areas of the cabin, reducing the amount of irrelevant data and improving the efficiency of the object detection process. Additionally, bilinear or bicubic resampling may be used to resize the cropped images to the appropriate resolution required by the VLM, maintaining the aspect ratio to avoid distortion. In some examples, upsampling algorithms may also be employed to enhance image quality, facilitating better object detections by improving the resolution of the input image data.”For further optimization, semantic segmentation may be performed to divide the image into segments based on pixel similarity, isolating potential object regions. This technique may allow the VLM to focus on the most relevant areas of the image and improve detection accuracy by eliminating irrelevant background data. In some examples, superpixel segmentation (SLIC-Simple Linear Iterative Clustering) may be applied to group pixels into compact, visually similar regions, simplifying the image for more efficient object detection while preserving important details.

In preparation for object identification, edge detection, such as the Canny Edge Detector, may be employed to highlight the boundaries of objects within the image. This enhances the clarity of object outlines, especially in cluttered environments like vehicle cabins. Furthermore, object detection proposal algorithms (e.g., selective search or region proposal networks) may be used to generate bounding boxes around potential objects, narrowing down the regions for VLM analysis and improving overall processing efficiency.

To improve the robustness of the system, image normalization techniques (e.g., Z-score normalization or Min-Max normalization) may be applied to standardize pixel values across the image, ensuring consistency in the data passed to the VLM. Additionally, data augmentation techniques (e.g., rotation, flipping, and color jitter) may be used to simulate various real-world conditions, such as different object orientations or lighting conditions, thereby improving the adaptability of the VLM to detect objects in a wide range of environments.

In some embodiments, the system may implement image tiling, where the image is divided into smaller tiles or patches, each processed independently by the VLM. This allows for parallel processing, enabling the system to handle larger images efficiently while ensuring real-time performance. Similarly, image pyramid techniques may be utilized, creating multiple scaled versions of the image, which allows the system to detect objects of different sizes, improving the accuracy of both small and large object detection.

Additionally, the system may benefit from the use of attention mechanisms, which may allow the VLM to prioritize certain areas of the image based on context (e.g., focusing on seats or storage areas where objects are likely to be found). This selective focus reduces the computational load and increases the accuracy of object detection by guiding the VLM to the most relevant areas of the image.

To support these processing tasks, the system may include one or more instances of computational circuitry 106. This circuitry may comprise multiple components, such as multi-core central processing units (CPU) for general processing and one or more graphics processing units (GPU) or neural processing units (NPU) to handle computationally intensive tasks. These components may operate independently or in parallel, with inter-process or event-based communications facilitating coordination between different computational units. The GPU or NPU may be optimized for parallel processing, allowing multiple image regions or tiles to be processed simultaneously across single or multiple GPUs, reducing latency and enabling real-time object detection and identification.

The use of these advanced image processing algorithms and techniques may optimize the images for VLM inference, allowing the system to accurately detect and identify various objects within the vehicle cabin, regardless of the type of object or its intended application. The system may be adaptable to identify a wide range of items, including personal belongings, commercial goods, or other objects relevant to different use cases. The computational circuitry 106 may be equipped with sufficient memory resources (e.g., RAM and storage) to handle the high volume of image data, intermediate cropped or resized images, and the results of the object detection process, ensuring the system operates efficiently in real time.

The VLMs 108 may be configured as an integral part of the system 100 in some examples, facilitating object recognition and identification through advanced deep learning algorithms and language processing techniques. These models may be pre-trained on extensive datasets containing a wide variety of objects and environments, enabling them to generalize across different object types and scenarios commonly encountered in vehicle cabins. In some examples, the VLMs 108 may operate by processing visual input data captured by cameras 104 and generating structured outputs in the form of textual descriptions or object labels corresponding to the detected items.

The VLMs 108 may be based on multimodal learning frameworks that combine both visual and language representations. This allows the models to simultaneously analyze image data and interpret language prompts that describe the types of objects the system is tasked with identifying. Upon capturing the image data, the system may prepare it through a series of preprocessing steps, after which the images may be appended to a custom system prompt specifically engineered to guide the model's focus on the desired objects within the vehicle cabin.

For example, the system prompt may instruct the model to identify items commonly found in vehicles, such as bags, electronic devices, or commercial goods. The prompt may include context-specific information, directing the model to focus on certain regions of the image, such as seats, floors, or storage areas. This prompt-driven object detection enables the VLMs 108 to adapt dynamically to different environments and tasks without requiring the objects to be pre-tagged or included in a predefined object database.

In some examples, the VLM may analyze the visual data using a deep neural network architecture, such as a convolutional neural network (CNN) combined with a transformer-based language model. The CNN may extract high-level visual features from the image data, such as shapes, textures, and edges, which are advantageous for recognizing objects in varying lighting conditions or with partial occlusions. These visual features may be converted into a feature vector, representing the key characteristics of the objects present in the image.

The extracted feature vector may then be processed by the language model component of the VLM, which operates using an attention mechanism to associate specific parts of the visual data with the corresponding textual descriptions provided in the prompt. The attention mechanism may prioritize different regions of the image based on the relevance of the detected visual features to the language prompt, allowing the model to focus on areas where the most relevant objects are likely to be located. This may be especially useful when dealing with cluttered environments, where multiple objects are present in close proximity, or when objects are partially obscured by other elements in the cabin.

Once the visual data is processed, the VLMs 108 may generate structured output, which could include textual descriptions, object labels, or bounding boxes indicating the presence and location of detected objects within the cabin. These outputs may then be further refined using object localization techniques, which involve associating the model's response with specific regions of the image, such as the cropped quadrants or other defined regions of interest within the vehicle.

In some examples, object localization may be achieved by correlating the bounding boxes or object labels generated by the model with the corresponding cropping region. For instance, if the image has been divided into quadrants, the system may match the identified objects with the specific quadrant in which they were detected, thereby localizing the object's position within the vehicle. This localized information may be critical for providing meaningful notifications to the user, such as identifying whether an object has been left on a particular seat or floor area.

To enhance accuracy and adaptability, the VLMs 108 may be fine-tuned based on specific operational environments. Fine-tuning may involve retraining the models on smaller, task-specific datasets that reflect the types of objects and conditions typically found within the vehicle cabin. Additionally, fine-tuning may include instruction fine-tuning, where the models are adjusted based on specific user or system instructions, allowing the VLMs to better interpret context-specific commands or prompts. For example, the model may be fine-tuned to recognize objects under various lighting conditions, such as during the day or night, and to detect objects that may be partially hidden or obscured by other items. This fine-tuning process ensures that the model maintains high accuracy and robustness across different environments, object types, and operational scenarios.

In some examples, VLMs 108 may also operate in parallel, with multiple image regions or cropped segments processed simultaneously. This parallelization of object detection tasks ensures that the system can handle large images or complex environments in real time, without incurring significant delays. By processing each image quadrant or region of interest independently, the system can evaluate multiple parts of the vehicle cabin simultaneously, improving overall detection speed and efficiency.

Furthermore, the use of multimodal fusion techniques within the VLM enables the model to combine visual features with contextual language inputs, allowing for more nuanced object detection. This may allow the system to detect specific object types based on context, such as distinguishing between a laptop and a book based on their location within the vehicle (e.g., in the back seat vs. on the dashboard). Multimodal fusion ensures that the model can make more informed decisions about the nature of the objects being detected, improving both the accuracy and relevance of the object detection results.

In contrast to traditional object recognition systems that may rely on predefined object databases or manual tagging, the VLMs 108 may dynamically detect and identify untagged, diverse, and evolving objects within the vehicle. This capability allows the system to operate without prior knowledge of the specific objects present, making it suitable for applications that involve frequently changing items, whether personal belongings, commercial goods, or other types of objects.

Through the use of advanced neural network architectures, attention mechanisms, and multimodal learning, the VLMs 108 offer a flexible and robust solution for detecting and identifying a wide range of objects within the vehicle cabin, adapting to varying operational conditions and object types. This approach enables real-time object detection with high accuracy and provides users with actionable insights about the objects present in their vehicles.

Continuing with the example in FIG. 1, vehicle integration circuitry 110 may facilitate communication between the object detection system and the vehicle's internal systems. This circuitry may interface with the vehicle's Controller Area Network (CAN) bus, enabling the system to detect relevant vehicle events, such as gear changes, door openings, or other operational triggers. In some examples, the system may respond to autonomous driving events, such as the vehicle reaching a destination. The vehicle integration circuitry 110 may ensure that the system operates in conjunction with existing vehicle functionalities, optimizing system performance and power consumption.

The user interface/display 112 may provide a visual or auditory notification to the user, informing them of detected objects within the vehicle cabin. In some examples, the user interface may be integrated with the vehicle's infotainment system, displaying a list of detected objects and their locations within the cabin. The display may include graphical representations of the vehicle interior, showing icons or images representing each detected object. Alternatively, the system may provide auditory notifications or alerts to the driver, reminding them of objects left behind. The user interface 112 may be customizable, allowing users to configure notification preferences or request additional information about detected objects.

Communication circuitry 114 may enable external connectivity, allowing the system to communicate with cloud-based services or mobile devices. In some embodiments, the communication circuitry 114 may include wireless communication modules, such as cellular modems, Wi-Fi, or Bluetooth, enabling remote notifications and data logging. This circuitry may facilitate features such as sending alerts to mobile devices or uploading data related to detected objects, including timestamps, GPS locations, and images, to a secure cloud service (e.g., 406). In some examples, the mobile device 404 may also communicate with the cloud-based service 406, enabling the user to access the system remotely. For example, the mobile device may retrieve data stored in the cloud service, such as previously detected objects or location history, and display the information to the user. This allows for seamless interaction between the vehicle system, the cloud, and the mobile device, enhancing overall system functionality, particularly for security and convenience purposes, by enabling real-time access to data and remote monitoring.

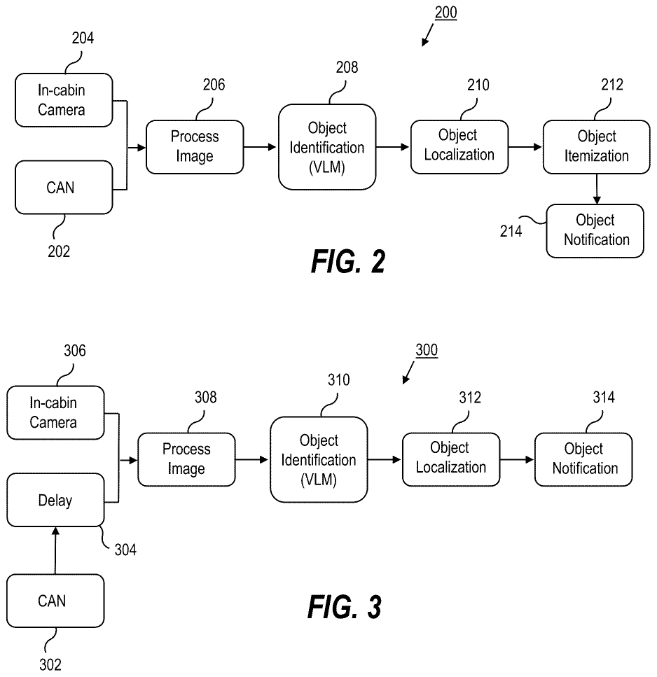

FIG. 2 illustrates a process flow for object detection and identification triggered by a vehicle event, such as shifting to “PARK” or another operational trigger detected via the vehicle's Controller Area Network (CAN) or another event-based signal. The system is designed to detect and identify objects placed in open and visible areas of the vehicle cabin and provide real-time notifications to the user via in-vehicle displays. This ensures the user is made aware of any objects before exiting the vehicle.

In block 202, the system detects a trigger event, such as shifting to “PARK” or receiving another operational signal via the vehicle's Controller Area Network (CAN). These events may include manual triggers (e.g., door opening) or automated system inputs (e.g., when an autonomous vehicle reaches its destination). The detection of this event prepares the system to initiate the in-cabin camera for image capture.

In block 204, one or more in-cabin cameras (e.g., 104 from FIG. 1) are activated to capture images of the vehicle's interior. The cameras are strategically positioned to monitor key areas of the cabin, such as seats, floors, and exposed storage compartments, ensuring full coverage. The cameras are also calibrated to adjust for varying lighting conditions, ensuring clear image capture under different environmental factors such as daylight, shadows, or low-light scenarios.

In block 206, the captured images are preprocessed by the computational circuitry (e.g., 106 from FIG. 1). Preprocessing may include adjustments for brightness, contrast, and noise reduction, as well as image cropping into specific regions of interest. In some embodiments, the image may be divided into quadrants or sections corresponding to key cabin areas, such as front and rear seats or floor spaces. This step ensures the image is optimized for further analysis by the system's object detection algorithms.

In block 208, the VLMs (e.g., 108 from FIG. 1) analyze the preprocessed images to detect and identify objects visible within the cabin. These models use advanced machine learning techniques to recognize various objects based on visual features such as shapes, colors, and textures. The models are trained to identify items commonly found in vehicle environments, such as bags, electronic devices, and personal items, leveraging both visual data and language-based prompts to ensure accurate detection.

In block 210, the system localizes the identified objects within the vehicle. Each detected object is associated with a specific region of the cabin, allowing the user to easily determine the exact location of the object. For example, an object detected on the front passenger seat is localized to that specific seat, enabling the user to identify its position.

In block 212, the system generates a list of the detected objects and their respective locations, which is then displayed to the user through the vehicle's infotainment system (e.g., 112 from FIG. 1). The user interface provides a visual representation of the vehicle's cabin, highlighting the identified objects and their locations. This real-time interaction allows the user to review the objects while still inside the vehicle, ensuring that they address any important items before exiting. In block 214, the process concludes with the in-vehicle notification being presented to the user. The user can take immediate action based on the information provided, such as retrieving personal belongings. After this, the system either resets or enters an idle state, ready for further vehicle events that may trigger additional object detection.

FIG. 3 illustrates a process flow for object detection and identification triggered by a vehicle event, such as a “door open” signal detected via the vehicle's Controller Area Network (CAN) or another operational signal. This process is distinct from FIG. 2 in that it focuses on providing remote notifications to the user's mobile device, ensuring the user is informed of any objects left behind in the vehicle after exiting.

In block 302, the system detects a vehicle event, such as the “door open” signal through the CAN system, which indicates the user is preparing to exit the vehicle. The CAN event serves as a trigger to initiate the object detection process.

In block 304, the in-cabin cameras (e.g., 104 from FIG. 1) are activated to capture images of the vehicle's interior. The cameras are positioned to monitor key open areas of the vehicle, such as the seats, floor, and accessible storage compartments. The cameras automatically adjust to the current lighting conditions to ensure clear image capture as the user prepares to leave the vehicle.

In block 306, the captured images are processed by the computational circuitry (e.g., 106 from FIG. 1). Preprocessing steps may include exposure correction, noise reduction, and image segmentation into regions of interest, just as in the previous process flow. This ensures that the system efficiently focuses on areas of the cabin where objects are most likely to be found, optimizing the image for subsequent analysis.

In block 308, the VLMs (e.g., 108 from FIG. 1) analyze the preprocessed images to detect and identify any objects that may have been left behind as the user exits the vehicle. The models leverage machine learning techniques to compare the visual data against known object categories, identifying a wide range of items based on their visual characteristics. These detected items may include personal belongings or other valuable objects.

In block 310, the system localizes the identified objects by mapping them to specific regions of the vehicle cabin, based on the cropped images. For example, an object detected in the rear seat area will be associated with that location, providing the user with detailed information about where each object is located within the vehicle.

In block 312, the system prepares a notification containing a summary of the detected objects and their respective locations. The system classifies objects based on their importance, highlighting personal belongings or high-value items that may need retrieval after the user has exited the vehicle. This classification helps prioritize which objects should be brought to the user's attention first.

In block 314, the notification is transmitted to the user's mobile device through the communication circuitry (e.g., 114 from FIG. 1). The mobile device, which may be equipped with a dedicated application (discussed in FIG. 6), receives the notification and presents the user with an itemized list of the detected objects and their locations inside the vehicle.

After the notification is transmitted, the user receives the notification on their mobile device (e.g., 404). An app allows the user to interact with the list, acknowledging the detected objects and marking those that were intentionally left behind, or setting reminders to retrieve certain items later. This remote functionality ensures that the user remains informed of any objects left inside the vehicle, even after exiting. The user may interact with the mobile app to review the detected objects. Once the notification is acknowledged, the system may reset or return to an idle state, awaiting further vehicle events that may trigger additional object detection. This ensures that the system continues to function as needed, even in future scenarios. In some examples, the process may conclude without user interaction, such as when the user ignores or clears the banner notification on their mobile device. In such cases, acknowledgment of the notification is optional, and the system will automatically reset or enter an idle state after the notification is triggered, even if no action is taken by the user. This ensures that the system continues to operate seamlessly, ready for future detection events without requiring direct user input.

By using remote notifications, the system extends its functionality beyond in-vehicle alerts, providing the user with continuous access to information about the objects inside their vehicle after they have exited. This two-stage detection process offers seamless integration between in-vehicle and mobile device notifications, ensuring the user is always aware of any objects left behind.

In addition to the processes described in FIGS. 2 and 3, the system (e.g., 100) may be configured to handle scenarios where objects are only partially visible within the vehicle cabin. For instance, an object such as a phone may fall out of a user's pocket and slide halfway down the seat, resulting in partial occlusion. In such scenarios, the VLMs (e.g., 108 from FIG. 1) may be configured to perform partial object detection, recognizing objects based on the visible portions, even if they are partially obscured.

The VLMs may be trained using large datasets that include objects in various states of occlusion, allowing them to recognize objects that are not fully visible. In the case of a phone partially hidden under a seat, the model may leverage convolutional neural networks (CNNs) to extract key visual features such as the phone's edges, shape, texture, or color patterns. These extracted features may be compared with the model's training data, enabling the system to match the visible portion of the object to a complete phone.

Furthermore, the system may utilize spatial context to infer the identity of partially obscured objects. For example, the model may consider the position and surrounding area of the detected object, as well as the fact that personal electronic devices are common in vehicle environments. This contextual understanding may help the model accurately identify a phone, even if part of it is hidden by the seat.

The system's robustness to partial visibility may be enhanced by the use of attention mechanisms within the VLM. These mechanisms may focus on the most distinctive visible features of the object, ensuring that sufficient information is gathered for accurate identification despite occlusion. Additionally, prompt engineering or language-based prompts may guide the model to prioritize certain types of objects (e.g., phones, electronic devices) that are likely to be present in the vehicle cabin.

The ability to perform partial detection may be further strengthened by the use of pretrained models, which may be capable of recognizing objects even when only part of the object is visible. For example, bounding box predictions generated by the model may indicate the presence of a partially visible phone, and through the model's learned object shape recognition, the system may infer that the remaining portion of the phone is obscured by the seat. The system may also employ object proposal networks to generate hypotheses about the presence of partially visible objects based on the available visual cues.

This feature may be advantageous in real-world vehicle environments where objects often shift or become partially hidden due to movement. By incorporating advanced object detection techniques that account for partial visibility, the system may ensure that the user is informed about objects left inside the vehicle, even if those objects are not fully exposed to the cameras.

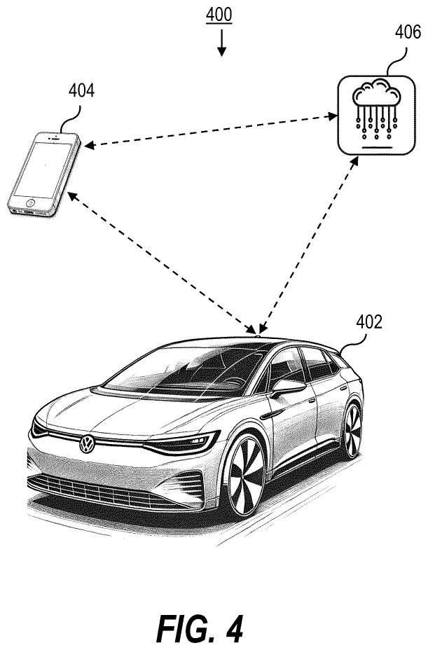

FIG. 4 illustrates a communication framework 400 in which the vehicle 402 may be configured to communicate with a portable device, such as a mobile phone 404, and a cloud computing system 406. This communication framework allows the system to extend its object detection and identification capabilities by providing remote notifications and data storage using a range of communication techniques.

The vehicle 402 may include a communication module that supports various communication protocols such as cellular (e.g., LTE, 5G), Wi-Fi, Bluetooth, or vehicle-specific communication standards. These protocols may enable the vehicle 402 to transmit and receive data from external devices and services. For example, the vehicle 402 may communicate directly with the portable device 404 via Bluetooth or Wi-Fi for immediate and local notifications of detected objects. In other scenarios, the vehicle may send data to the portable device 404 via cellular communication through a cloud-based service, allowing for notifications and updates even when the user is not in close proximity to the vehicle.

The portable device 404, which may include a smartphone or other connected device, may be configured with a dedicated application that interfaces with the vehicle's object detection system. Through this app, the user may receive notifications, interact with detected objects (e.g., by acknowledging objects or setting reminders), and review detailed information about the items left behind in the vehicle. Additionally, the portable device 404 may allow the user to input specific commands to search for a particular class of items. For example, the user could input “headphones,” and the system prompt will be updated accordingly, instructing the VLM to specifically search for “headphones” within the vehicle. The communication between the vehicle 402 and the portable device 404 may be triggered by specific vehicle events, such as detecting a “door open” signal or transitioning to an idle state, as described in FIG. 3. In this way, the system ensures that the user remains informed about the objects in the vehicle, even after exiting.

In addition to communicating with the portable device 404, the vehicle 402 may also transmit data to a cloud computing system 406. This cloud-based infrastructure enables the storage and processing of object detection data, which may include information about the identified objects, timestamps, GPS coordinates, and images captured by the in-cabin cameras (e.g., 104 from FIG. 1). By leveraging cloud storage, the system ensures that users can access historical data or retrieve records of objects left behind for future reference, such as for insurance claims or security purposes.

The communication framework 400 may also allow for updates to the vehicle's detection system through the cloud computing system 406. For example, the system may receive software updates to improve object detection algorithms or to extend the functionality of the VLMs (e.g., 108 from FIG. 1). These updates may be automatically applied to the vehicle's system to enhance the overall detection performance and ensure the vehicle remains up-to-date with the latest advancements in object detection technology.

The cloud computing system 406 may further serve as an intermediary between the vehicle 402 and the portable device 404, facilitating communication between the two when direct communication is not possible. For example, if the vehicle and the portable device are not within range of each other, the cloud computing system 406 may receive data from the vehicle 402 and relay the necessary notifications or updates to the portable device 404. This ensures seamless and uninterrupted communication, regardless of the user's location relative to the vehicle.

It should be noted that the portable device 404 may refer to any type of portable or mobile device capable of communication with the vehicle 402. This includes, but is not limited to, smartphones, tablets, smartwatches, or other wearable devices that can interact with the vehicle's system via Bluetooth, Wi-Fi, cellular networks, or other communication protocols. The portable device 404 may be equipped with a dedicated application to facilitate the described functions, such as receiving notifications, interacting with detected objects, and managing reminders for items left in the vehicle.

Similarly, the cloud computing system 406 may refer to any server-based infrastructure capable of supporting the communication, data storage, and processing required for the described functions. This may include public or private cloud servers, hybrid cloud solutions, or distributed server networks that handle the transmission and storage of object detection data, software updates, and notifications between the vehicle 402 and the portable device 404. The cloud computing system 406 may be designed to support real-time communication and ensure that the system remains scalable and flexible, adapting to different vehicle configurations and user needs.

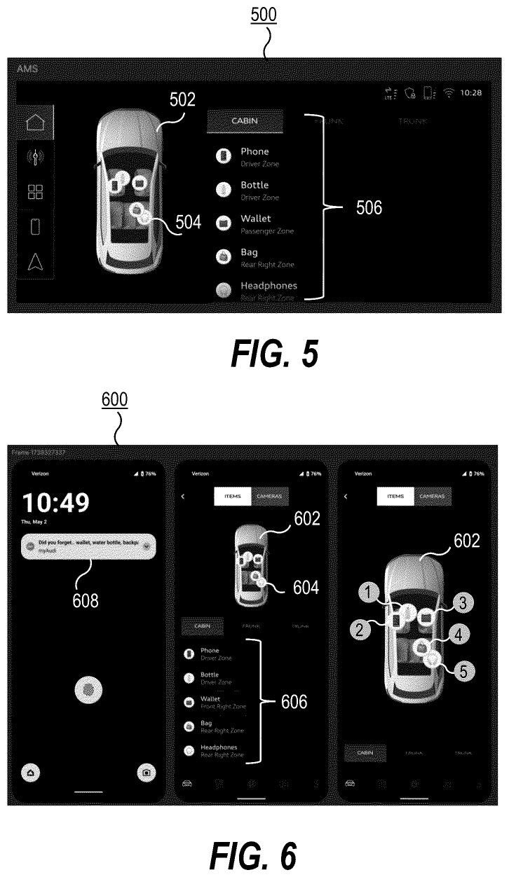

FIG. 5 illustrates an exemplary graphic view 500 presented on the vehicle's in-vehicle display system, such as an infotainment screen, after the object detection process is completed, as described in FIG. 2. The graphic view 500 shows a representation of the vehicle 502 and visual indicators for identified objects 504 within the vehicle cabin. These objects are overlaid on the vehicle representation based on their estimated physical locations, allowing the user to visually understand where each object is situated.

In addition to the graphical representation, the system provides a listing 506 of the identified objects. The listing 506 may include object names, descriptions, or other relevant information related to the detected objects. This list allows the user to see a detailed breakdown of the objects in the cabin without relying solely on the graphical vehicle representation 502. The listing 506 is updated in real time once the detection and identification process is complete, providing a comprehensive overview of the objects within the cabin, their positions, and their relative importance.

FIG. 6 shows a similar exemplary graphic view 600 presented on the screen of a portable device, such as a mobile phone (e.g., 404 from FIG. 4), after a process, such as that described in FIG. 3, has completed. Similar to FIG. 5, the graphic view 600 includes a representation of the vehicle 602 and the estimated locations 604 of the identified objects. The graphic view 600 serves as a remote interface for the user, allowing them to see the objects left in the vehicle even after they have exited. A listing 606 of the identified objects is provided, similar to the one shown in FIG. 5, ensuring that the user can review a detailed breakdown of the items detected.

A notification 608 is provided within the portable device's user interface, alerting the user of the identified objects. This notification may be triggered by events such as the user opening the vehicle door or transitioning to a remote state as described in FIG. 3. The notification 608 serves as a prompt for the user to interact with the system, either by reviewing the object listing 606 or taking action to retrieve any items that may have been unintentionally left behind.

On the right-hand side of the graphic view 600, the system may include a selectable menu for each identified object (labeled “1” through “5”). These menu options correspond to specific objects, allowing the user to interact with each one individually. When the user selects an object from the menu, one or more sub-menus may be displayed (not shown), providing additional options for managing that object. These sub-menus may allow the user to specify various settings for each object, such as ranking its importance.

For example, the user may rank an object as “extremely important,” in which case the system may display that object with a distinguishing visual indicator, such as a different color or animation, in future interactions. This helps the system emphasize high-priority items that the user may wish to retrieve first. Conversely, if the user designates an object as “not important,” the system may choose to omit that object from future notifications, thereby reducing the clutter of irrelevant information. Intermediate levels of importance can also be set, allowing the user to fine-tune the system's behavior based on their preferences. These features ensure that the system adapts to the user's needs, improving the relevance and accuracy of future object detections.

By providing both a visual representation of the vehicle's interior and a detailed object listing, the system enhances the user's ability to manage and interact with the objects detected inside the vehicle. Whether through the in-vehicle display (FIG. 5) or the remote mobile device (FIG. 6), the system ensures that the user is always informed and capable of taking action regarding the objects detected in the cabin. Additionally, by allowing the user to rank the importance of detected objects and customize how they are handled in future detections, the system offers a flexible, adaptive approach to object management, improving both convenience and user satisfaction. Optionally, the user may disable notifications altogether, preventing banner notifications from being displayed. However, even with notifications disabled, the user can still passively view the object list on the screen at any time, ensuring access to the information without active alerts.

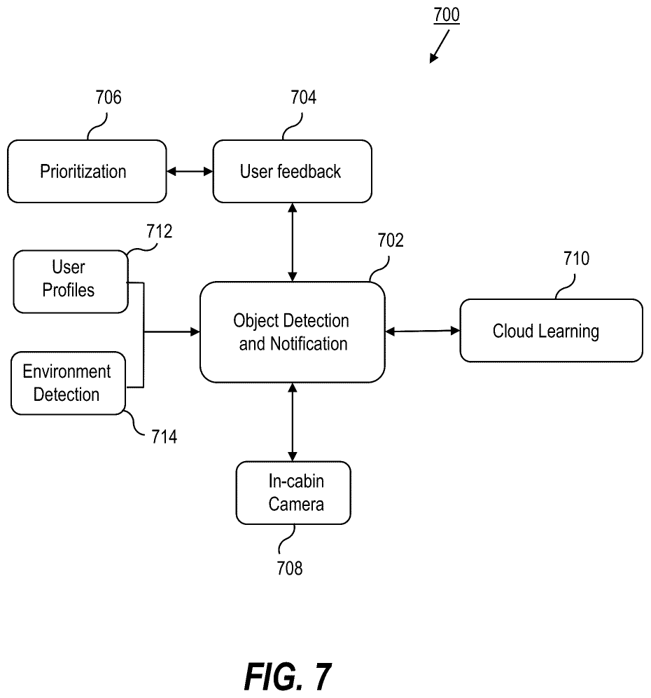

FIG. 7 illustrates an adaptive object detection system that may be incorporated into detection and notification functions, such as those described in FIG. 1. This embodiment enhances the core detection system by introducing several adaptive features, including user feedback loops, user profiles, environment and context detection, object prioritization, and cloud-connected learning. These features allow the system to continuously evolve and adjust its behavior based on individual user preferences, environmental conditions, and real-time feedback.

The system may include an object detection and notification module 702, which operates similarly to the detection system described in FIG. 1. The object detection and notification module 702 captures images of the vehicle's interior via in-cabin cameras 708 and processes these images using VLMs as described previously. These models analyze visual characteristics such as shape, color, and texture to detect and identify various objects within the cabin, including personal belongings and other commonly found items. The system may operate in real time, ensuring that notifications are generated promptly when objects are detected.

The system further includes a user feedback module 704, which allows users to interact with detected objects and provide input regarding their relevance or significance. In some configurations, users may mark objects with binary designations, such as “important” or “not important,” through the vehicle's interface (e.g., 112 in FIG. 1) or via a connected mobile device. Alternatively, the system may support more granular feedback options, such as a numerical scale (e.g., a rating from 1 to 5) or a tiered priority system (e.g., low, medium, high). These additional configurations enable users to provide more precise feedback on object significance. For instance, a user may rank an item like a phone as “high priority,” while assigning “low priority” to less critical objects, such as a reusable water bottle.

This feedback is used to adjust future detections, creating a dynamic feedback loop. The system may prioritize or deprioritize objects based on cumulative user feedback over time, either by increasing the visibility of frequently marked high-priority items or reducing notifications for low-priority objects. For example, if a user frequently ranks certain objects (e.g., a gym bag) as low priority, the system may deprioritize notifications for similar objects in the future. Conversely, high-priority items, such as wallets or electronics, may receive increased emphasis in subsequent notifications, potentially with visual cues such as highlighted colors or animations to draw the user's attention.

In addition, the system may enable users to group related objects (e.g., “work items” or “personal items”) and assign collective importance to these groups, allowing for more efficient object management in cluttered environments.

The system may also incorporate user profiles 712, which enable the system to differentiate between different users in a shared vehicle environment. For instance, the system may automatically associate certain objects with specific users (e.g., work-related items for User A or school-related items for User B) and adjust notifications based on each user's preferences. The system can recognize different users by detecting their connected devices or other identifiers, ensuring that each user's profile is applied seamlessly when they are operating the vehicle.

In addition to user customization, the system includes an object prioritization module 706, which adjusts the emphasis given to detected objects based on user feedback and historical interactions. High-priority items may be visually highlighted on the vehicle's display or the user's mobile device, such as through color-coding or animation, to ensure they capture the user's attention. Objects deemed less relevant or irrelevant may be filtered out of notifications to reduce unnecessary alerts.

To handle situations where the vehicle interior may be cluttered, the system is equipped with automated object grouping and classification capabilities within the object detection and notification module 702. This functionality enables the system to group similar objects together, such as multiple pieces of trash, and provide a collective notification (e.g., “multiple trash items detected”) rather than listing each item individually. This helps reduce notification overload and ensures that the user can focus on more relevant personal items. The object prioritization module 706 works in conjunction with the detection module to prioritize these grouped objects based on user feedback and historical data.

Another feature of the system is environmental and context detection 714, which allows the system to adjust its detection criteria based on environmental factors or user behavior patterns. For example, during colder months, the system may prioritize detecting winter accessories such as gloves or scarves. Similarly, it may recognize situational contexts—such as when the vehicle is near a school or work environment—and adjust detection priorities based on the expected objects for that scenario (e.g., deprioritizing school bags during work commutes).

The system may also incorporate cloud-connected learning 708, which enables the detection system to continuously update and evolve by accessing cloud-based data. The cloud infrastructure may provide updates to the VLMs, ensuring that the system stays current with new object types and detection algorithms. For instance, if new consumer products become common, the system can learn to recognize and prioritize these objects based on data updates received from the cloud.

The user feedback loops 704 refine the system's detection and notification processes over time. Every time a user provides feedback on detected objects, the system processes this input and adjusts its behavior accordingly. This feedback loop ensures that the system becomes more responsive to the user's preferences over time, improving the relevance and effectiveness of future notifications.

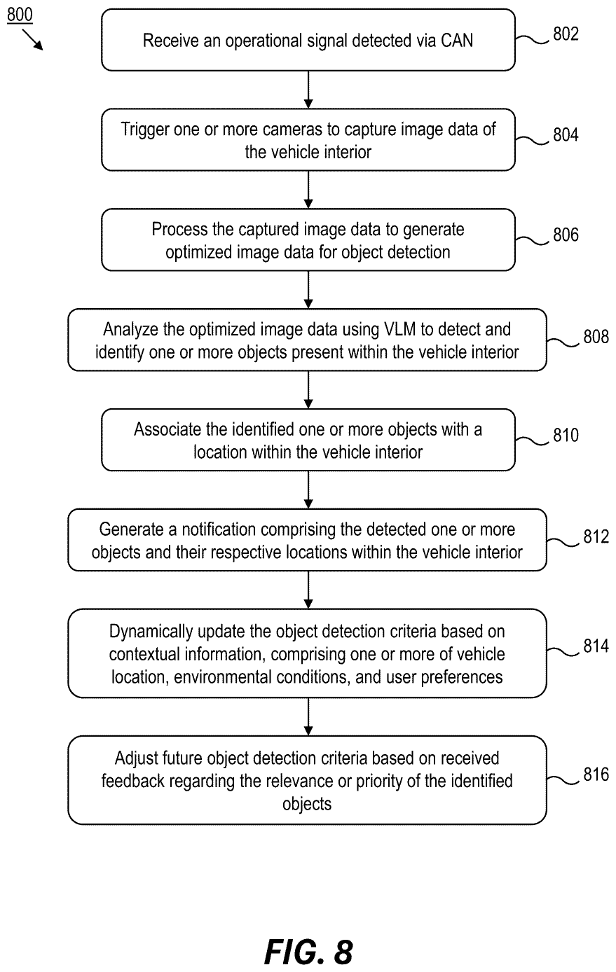

FIG. 8 illustrates a process flow for object detection and identification triggered by an operational signal detected via the vehicle's CAN. In block 802, the system detects a trigger event, such as shifting into park, a door opening, or another operational signal detected through the CAN system (e.g., 110 from FIG. 1). This trigger initiates the object detection process by activating the in-cabin cameras (e.g., 104 from FIG. 1). In block 804, the in-cabin cameras capture image data of the vehicle's interior, focusing on regions where personal objects are likely to be located, such as seats, floors, and storage compartments. The cameras may be equipped with automatic exposure adjustment to account for varying lighting conditions, ensuring that the captured images are clear and usable regardless of the vehicle's environment.

In block 806, the captured image data is processed by the computational circuitry (e.g., 106 from FIG. 1) to optimize the image for object detection. This processing step may include brightness and contrast adjustments, noise reduction, and image cropping to focus on regions of interest within the vehicle cabin. These steps are advantageous for preparing the image for efficient analysis by the system's object detection algorithms. In block 808, the system analyzes the processed image data using a VLM (e.g., 108 from FIG. 1). The VLM is configured to detect and identify objects based on their visual and contextual characteristics, such as shapes, colors, and textures. The VLM may also incorporate language-based prompts to improve detection accuracy based on expected object types in the vehicle's environment.

In block 810, the system associates the identified objects with their respective locations within the vehicle. For example, an object detected on the front passenger seat is localized to that specific seat, allowing the system to notify the user of the object's precise location. In block 812, the system generates a notification containing the identified objects and their corresponding locations within the vehicle cabin. This notification may be displayed on the vehicle's infotainment system (e.g., 112 from FIG. 1) or transmitted to the user's mobile device (e.g., 404 from FIG. 6), ensuring that the user is informed of any objects before exiting the vehicle.

In block 814, the system dynamically updates its object detection criteria based on contextual information, such as vehicle location, environmental conditions, and user preferences. For instance, the system may adjust its detection sensitivity based on whether the vehicle is parked in a high-traffic area or under low-light conditions. This adaptability allows the system to optimize its performance across a wide range of scenarios. Finally, in block 816, the system adjusts future object detection criteria based on feedback received from the user regarding the relevance or priority of detected objects. For example, if the user frequently deems certain objects as unimportant, the system may deprioritize those objects in future detections, enhancing the efficiency of the object detection process.

In some examples, signals may be received from a user interface (e.g., 112), the signals indicating user inputs regarding the relevance or priority of the detected objects. The vehicle (e.g., 402) may be configured to adjust subsequent object detection criteria based on the received signals, allowing the system to adapt to the user's preferences over time. The dynamic updating of object detection criteria may also involve modifying object prioritization based on contextual data. This contextual data may include historical user interaction patterns, vehicle operational states, or environmental changes detected by the vehicle, further enhancing the system's adaptability in different operational scenarios.

In another example, the contextual information used to update the object detection criteria may include user-specific preferences from a user profile stored in the vehicle or associated with a connected device (e.g., 404). These preferences may influence the system's object detection behavior, tailoring it to the specific needs of the individual user. Additionally, the cameras (e.g., 104) may be configured to capture image data of regions of interest within the vehicle based on pre-determined or real-time contextual factors, ensuring that the system focuses on areas where objects are most likely to be found. Finally, the system may group detected objects into categories based on user-defined priorities or object characteristics, generating a notification that presents the grouped objects in a more organized and user-friendly manner. This categorization allows the system to prioritize notifications based on the importance of the detected objects, enhancing the user experience.

In addition to personal and passenger-oriented applications, the object detection system may be adapted for use in commercial settings. In one embodiment, the object detection system may be configured for inventory tracking and management in delivery vehicles, warehouses, and other commercial environments.

For example, in a delivery vehicle scenario, the object detection and notification module 702 may be used to detect and track commercial goods, such as packages or inventory items, within the cargo area of a delivery van. The system may scan the vehicle's interior at designated intervals or after each delivery stop, ensuring that all scheduled items are accounted for. If an item is missing or misplaced, the system may provide a notification to the driver or a central system, alerting them to any discrepancies. This functionality could significantly reduce delivery errors, improve inventory tracking, and optimize route efficiency for logistics operators.

The system may also be implemented in a warehouse or distribution center setting, where it can assist in tracking goods as they are loaded onto trucks or moved between storage locations. By recognizing and identifying specific packages, boxes, or pallets using visual identifiers such as labels or barcodes, the system can verify that the correct items are loaded for each shipment. This integration could streamline loading operations and reduce the risk of inventory misplacement or loading errors.

In another embodiment, the system may be applied to construction or industrial vehicles for asset tracking. In such environments, the system could monitor the presence of tools, machinery, or other critical equipment. By detecting whether all required items are loaded and secured before departure, the system helps prevent lost or misplaced equipment during transportation between worksites.

Furthermore, the system may be used in fleet management and logistics operations. When integrated with existing fleet management software, the object detection system could provide real-time inventory updates for multiple vehicles, ensuring that each vehicle is properly loaded based on its assigned delivery route. The cloud-connected learning module 708 could aggregate data across a fleet, allowing businesses to optimize their logistics operations by analyzing patterns in inventory management, loading times, and delivery efficiency.

In a commercial setting, the environmental and context detection module 714 may be configured to adjust detection criteria based on the specific business scenario. For example, the system could adapt to varying cargo loads or detect environmental conditions, such as temperature-sensitive goods, and ensure proper handling of such items during transportation.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for detecting and identifying objects within a vehicle interior, comprising:
capturing image data of the vehicle interior using one or more cameras;
processing the captured image data to generate optimized image data for object detection;
analyzing the optimized image data using a vision-language model (VLM) to detect and identifying one or more objects present within the vehicle interior, wherein the VLM is configured to recognize one or more objects based on their visual and contextual characteristics;
associating the identified one or more objects with a location within the vehicle interior;
generating a notification comprising the detected one or more objects and one or more respective locations within the vehicle interior;
dynamically updating the object detection criteria based on contextual information, comprising one or more of vehicle location, environmental conditions, and user preferences; and
adjusting future object detection criteria based on received feedback regarding the relevance or priority of the identified objects.

2. The method of claim 1, further comprising receiving signals from a user interface, the signals indicating user inputs regarding the relevance or priority of the detected one or more objects, wherein the vehicle is configured to adjust subsequent object detection criteria based on the received signals.

3. The method of claim 1, wherein the dynamically updating of the object detection criteria further comprises modifying object prioritization based on contextual data, wherein the contextual data comprises one or more of historical user interaction patterns, vehicle operational states, and environmental changes detected by the vehicle.

4. The method of claim 1, wherein the contextual information further comprises user-specific preferences from a user profile stored in the vehicle or associated with a connected device, and adjusting the object detection criteria based on the user-specific preferences.

5. The method of claim 1, wherein the one or more cameras are configured to capture image data of configured regions of interest within the vehicle interior based on pre-determined or real-time contextual factors.

6. The method of claim 1, further comprising grouping the identified one or more objects into categories based on user-defined priorities or object characteristics, and generating a notification for the grouped objects.

7. The method of claim 1, wherein identifying one or more objects present within the vehicle interior comprises identifying at least one partially obscured object, wherein identifying the at least one partially obscured object comprises:
dividing the captured image data into segments using image segmentation;
processing the segmented image to identify visible portions of the partially obscured object; and
correlating the identified visible portions with stored object templates and contextual information to infer the presence and identity of the partially obscured object.

8. A system for detecting and identifying objects within a vehicle interior, comprising:
one or more cameras configured to capture image data of the vehicle interior; and
computational circuitry, operatively coupled to the one or more cameras, the computational circuitry being configured to:
process the captured image data to generate optimized image data for object detection;
analyze the optimized image data using a vision-language model (VLM) to detect and identify one or more objects present within the vehicle interior, wherein the VLM is configured to recognize one or more objects based on their visual and contextual characteristics;
associate the identified one or more objects with a location within the vehicle interior;
generate a notification comprising the detected one or more objects and one or more respective locations within the vehicle interior;
dynamically update object detection criteria based on contextual information, comprising one or more of vehicle location, environmental conditions, and user preferences; and
adjust future object detection criteria based on feedback regarding the relevance or priority of the identified objects.

9. The system of claim 8, further comprising a user interface configured to receive signals from the user, wherein the signals indicate user inputs regarding the relevance or priority of the detected one or more objects, and wherein the system is configured to adjust subsequent object detection criteria based on the received signals.

10. The system of claim 8, wherein the computational circuitry is further configured to dynamically update object detection criteria by modifying object prioritization based on contextual data, wherein the contextual data comprises one or more of historical user interaction patterns, vehicle operational states, and environmental changes detected by the vehicle.

11. The system of claim 8, wherein the contextual information further comprises user-specific preferences from a user profile stored in the vehicle or associated with a connected device, and the computational circuitry is configured to adjust the object detection criteria based on the user-specific preferences.

12. The system of claim 8, wherein the one or more cameras are configured to capture image data of predefined regions of interest within the vehicle interior based on pre-determined or real-time contextual factors.

13. The system of claim 8, wherein the computational circuitry is further configured to group the identified one or more objects into categories based on user-defined priorities or object characteristics, and to generate a notification for the grouped objects.

14. The system of claim 8, wherein the computational circuitry is further configured to identify at least one partially obscured object, wherein identifying the at least one partially obscured object comprises:
dividing the captured image data into segments using image segmentation;
processing the segmented image to identify visible portions of the partially obscured object; and
correlating the identified visible portions with stored object templates and contextual information to infer the presence and identity of the partially obscured object.

15. A method for detecting and identifying objects within a vehicle interior, comprising:
receiving an operational signal detected via a Controller Area Network (CAN);
in response to receiving the operational signal, triggering one or more cameras to capture image data of the vehicle interior;
processing the captured image data to generate optimized image data for object detection;
analyzing the optimized image data using a vision-language model (VLM) to detect and identify one or more objects present within the vehicle interior, wherein the VLM is configured to recognize the one or more objects based on their visual and contextual characteristics;
associating the identified one or more objects with a location within the vehicle interior;
generating a notification comprising the detected one or more objects and their respective locations within the vehicle interior;
dynamically updating the object detection criteria based on contextual information, comprising one or more of vehicle location, environmental conditions, and user preferences; and
adjusting future object detection criteria based on received feedback regarding the relevance or priority of the identified objects.

16. The method of claim 15, further comprising receiving signals from a user interface, the signals indicating user inputs regarding the relevance or priority of the detected one or more objects, wherein the vehicle is configured to adjust subsequent object detection criteria based on the received signals.

17. The method of claim 15, wherein dynamically updating the object detection criteria further comprises modifying object prioritization based on contextual data, wherein the contextual data comprises one or more of historical user interaction patterns, vehicle operational states, and environmental changes detected by the vehicle.

18. The method of claim 15, wherein the contextual information further comprises user-specific preferences from a user profile stored in the vehicle or associated with a connected device, and adjusting the object detection criteria based on the user-specific preferences.

19. The method of claim 15, wherein the one or more cameras are configured to capture image data of configured regions of interest within the vehicle interior based on pre-determined or real-time contextual factors.

20. The method of claim 15, further comprising grouping the identified one or more objects into categories based on user-defined priorities or object characteristics, and generating a notification for the grouped objects.
